(19) United States
(12) Patent Application Publication
(10) Pub. No.: US 2004/0253020 A1
(43) Pub. Date: Dec. 16, 2004

(54) Apparatus to drive a roller used in an electrophotographic printer

(76) Inventor: Joo-hwan Noh, Yongin-city (KR)

Correspondence Address: STANZIONE & KIM, LLP, 1740 N STREET, N.W., FIRST FLOOR, WASHINGTON, DC, 20036, US

(21) Appl. No.: 10/777,147

(22) Filed: Feb. 13, 2004

(30) Foreign Application Priority Data
Jun. 16, 2003 (KR) 2003-38798

(51) Int. Cl. G03G 15/00

(52) U.S. Cl. 399/167

(57) ABSTRACT

An apparatus to drive a roller used in an electrophotographic printer, which includes: a drum gear coaxially installed on the photoconductive drum to be rotated; a first passive roller gear coaxially installed on a first passive roller and in contact with and rotated by the photoconductive drum, and connected with the drum gear to be passively rotated, wherein the first passive roller gear is made of a material having a lower hardness than the drum gear to be able to absorb impulses due to a pitch error from gear teeth of the drum gear and the first passive roller gear.

### CROSS-REFERENCE TO RELATED APPLICATIONS

This application claims the benefit of Korean Patent Application No. 2003-38798 filed Jun. 16, 2003, in the Korean Intellectual Property Office, the disclosure of which is incorporated herein by reference.

### BACKGROUND OF THE INVENTION

1. Field of the Invention

The present invention relates to an apparatus to drive a roller used in an electrophotographic printer.

2. Description of the Related Art

As generally known in the art, an electrophotographic printer has: a photoconductive drum which is a photoconductive medium; a charging apparatus to charge a surface of the photoconductive drum to an electric potential of a predetermined level; an LSU (Laser Scanning Unit) to scan a laser beam on the charged surface of the photoconductive drum; a developing unit to develop an image on the photoconductive drum by supplying a toner to an electrostatic latent image region formed on the photoconductive drum by the scanning laser beam; and a transferring unit to deliver the toner developed on the photoconductive drum to a printing paper.

The charging apparatus has a charging roller that contacts and rotates with respect to the photoconductive drum so that a predetermined nip is maintained therebetween. While rotating in contact with the photoconductive drum, this charging roller uniformly charges the outer periphery of the photoconductive drum to a predetermined voltage. Therefore, it is important for the charging roller to continually rotate at a constant ratio with respect to the photoconductive drum. Generally, the charging roller rotates at the same tangent velocity as the photoconductive drum, and upon contact rotation, for prevention of velocity variation due to slip at the nip, the charging roller has a gear driving apparatus to rotate with respect to the photoconductive drum.

The gear driving apparatus has a drum gear coaxially installed with respect to the photoconductive drum, and a charging roller gear coaxially installed with respect to the charging roller to cooperate with the drum gear by being gear-connected to the drum gear. If the drum gear is given power from a predetermined driving source and rotated, the charging roller gear rotates the charging roller such as to be passively-rotated by the drum gear.

Therefore, the charging roller is rotated by a gear ratio of the charging roller gear and the drum gear, and charges the photoconductive drum while rotating.

However, according to the foregoing construction, the charging roller gear and the drum gear are generally made of materials such as polyacetal, or NYLON, PC (Polycarbonate) having strong hardness. Such materials have a strong hardness and thereof have a weak point in that precision of a gear is low upon manufacturing. Therefore, in the case that inter-axis distance between the charging roller and the photoconductive drum is changed due to deviation of parts, power transferring errors may be generated due to a so called gear pitch error. Due to such an error, impulse and velocity variation may be generated to the charging roller in contact with and rotated by the photoconductive drum so that the photoconductive drum may not be charged uniformly. If the photoconductive drum is not charged uniformly, density deviation is generated on an image and an image quality will be deteriorated.

### SUMMARY OF THE INVENTION

Accordingly, it is an aspect of the present invention to solve the above and/or other problems occurring in the prior art by providing an apparatus to drive a roller used in an electrophotographic printer, which is capable of absorbing impulses generated on a roller rotated by a photoconductive drum.

Additional aspects and advantages of the invention will be set forth in part in the description which follows and, in part, will be obvious from the description, or may be learned by practice of the invention.

The foregoing and/or other aspects of the present invention are achieved by providing an apparatus to drive a roller used in an electrophotographic printer, the driving apparatus comprising: a drum gear having gear teeth and coaxially installed on a photoconductive drum and to be rotated therewith; a first passive-roller in contact with and rotated by the photoconductive drum and having a first passive roller gear installed thereonand in contactwith the drum gear to passively-rotate, wherein the first passive roller gear is made of amaterial having a lower hardness than the drum gear to absorb impulses due to a pitch error from the gear teeth of the drum gear.

In another aspect of the present invention, the first passive roller gear is made of a polyester material or an elastomer series material.

In another aspect of the present invention, the first passive roller is a charging roller to charge a surface of the photoconductive drum to a predetermined voltage.

In yet another aspect of the present invention, the first passive roller gear has a shore D hardness ranging from 50D to 70D.

In yet another aspect of the present invention, the apparatus to drive a roller used in an electrophotographic printer further includes a second passive roller gear coaxially installed on a second passive roller in contact with and rotated by the first passive roller to cooperate with the first passive roller gear.

In still another aspect of the present invention, the second passive roller is a cleaning roller to clean a surface of the first passive roller.

In still another aspect of the present invention, the second passive roller gear is made of a polyester material or an elastomer series material.

The foregoing and/or other aspects of the present invention may also be achieved by providing an electrophotographic image forming apparatus forming an image on a recording medium and including a photoconductive drum forming a nip with a first passive roller, comprising a drum gear coaxially installed on the photoconductive drum to be rotated therewith, and a first passive roller gear coaxially installed on the first passive roller to be rotated therewith and in contact with the drum gear, the first passive roller gear being formed of a material that is softer than the material of the drum gear such that impulses from pitches between the drum gear and the first passive roller gear are absorbed to prevent velocity variations between the photoconductive drum and the first passive roller at the nip therebetween.

In an aspect of this embodiment, the first passive roller gear is made of a polyester material or an elastomer series material.

In another aspect of this embodiment, the first passive roller is a charging roller.

In yet another aspect of this embodiment, the electrophotographic image forming apparatus further comprises a second passive roller forming a nip with the first passive roller and to be rotated therewith and a second passive roller gear coaxially installed on the second passive roller and being in contact with and rotated by the first passive roller gear.

In still another aspect of this embodiment, the second passive roller gear is made of a polyester material or an elastomer series material.

The foregoing and/or other aspects of the present invention may also be achieved by providing a method of driving rollers used in an electrophotographic image forming apparatus including a photoconductive drum, comprising forming a drum gear coaxially on the photoconductive drum to rotate therewith, and forming a first roller comprising a first passive roller gear formed of a material having a lower hardness than the drum gear and coaxially formed on the first roller to rotate therewith, the first passive roller gear being positioned in contact with the drum gear such that the roller is passively driven by rotation of the photoconductive drum while absorbing impulses caused by pitch errors between the drum gear and the first passive roller gear.

In an aspect of this embodiment, the first passive roller gear is formed of a polyester material or an elastomer series material.

In another aspect of this embodiment, the first roller is a charging roller to charge the surface of the photoconductive drum.

In yet another aspect of this embodiment, the first passive roller gear is formed to have a Shore D hardness ranging from 50D to 70D.

The foregoing and/or other aspects of the present invention may also be achieved by providing an image forming apparatus comprising a photoconductive drum, a charging roller to charge a surface of the photoconductive drum, a drum gear rotating the photoconductive drum; and a passive gear in contact with the drum gear to rotate the charging roller, and having a lower hardness than the drum gear.

In an aspect of this embodiment, the photoconductive drum and the charging roller form a nip therebetween, and the drum gear directly contacts the passive gear.

In another aspect of this embodiment, a second passive gear is in contact with the passive gear to rotate together with the passive gear, and has a lower hardness than the drum gear.

In yet another aspect of this embodiment, a second passive gear is in contact with the passive gear to rotate together with the passive gear, and has a lower hardness than the drum gear.

In still another aspect of this embodiment, the passive gear is disposed between the drum gear and the second passive gear.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a structural view schematically showing an apparatus to drive a roller used in an electrophotographic printer according to an embodiment of the present invention;

FIG. 2 is a graph illustrating a comparison between an impulse generated upon driving of an apparatus to drive a roller used in an electrophotographic printer according to an embodiment of the present invention and an impulse generated in the prior art; and

FIG 3 is a structural view schematically illustrating an apparatus to drive a roller used in an electrophotographic printer according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

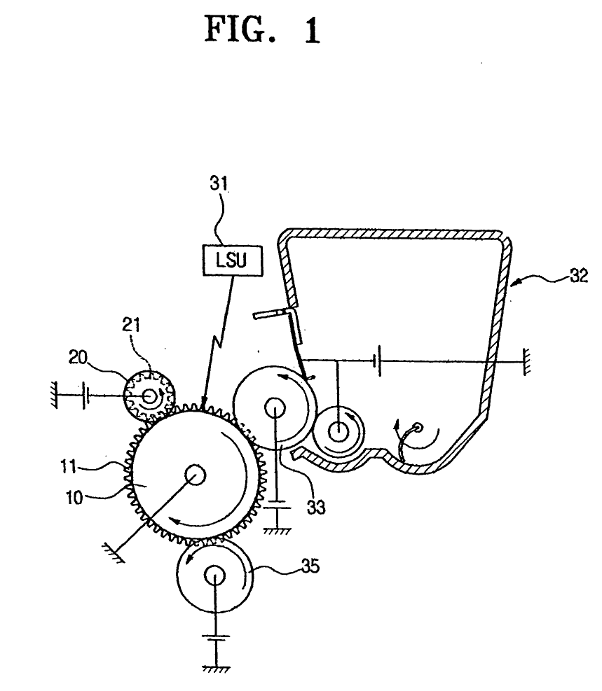

Referring to FIG. 1, an apparatus to drive a roller used in an electrophotographic printer according to an embodiment of the present invention rotates a first passive roller 20 in contact with and rotated by a photoconductive drum 10, which in turn is provided with power from a predetermined power source. In FIG. 1, the photoconductive drum 10 is rotatably installed, and a drum gear 11 is coaxially installed on the photoconductive drum 10. The drum gear 11 is given power from a driving motor through a power transferring unit not shown.

Here, the photoconductive drum 10 is a photoconductive medium widely used with a general electrophotographic printer. After being charged to a predetermined electric potential by a charging unit, the surface of the photoconductive drum 10 is partially exposed to light by a laser scanning unit 31 (LSU). Toner provided from a developing roller 33 of a developing unit 32 is delivered to the light-exposed surface of the photoconductive drum 10 so that a visible image is formed thereon. Such a visible image is delivered to a transferring member 35 in contact with and rotated by the photoconductive drum 10. The image delivered to the transferring member 35 is finally transferred to a printing paper (not shown) and printed. The photoconductive drum 10, which interacts with many peripheral devices while rotating, is rotated together with the. coaxially installed drum gear.

The drum gear 11 is made of a material having a strong hardness, such as polyacetal or NYLON, PC (Polycarbonate).

The first passive roller 20 passively operates by rotation of the photoconductive drum 10. In the embodiments of the present invention, a charging roller 20 to charge the surface of the photoconductive drum 10 is used as the first passive roller, as an example. However, it is to be understood that any other roller that may be required to be driven by the photoconductive drum 10 may be used as the first passive roller. The charging roller 20 plays a role of uniformly charging the surface of the photoconductive drum 10 to a constant electric potential while rotating at a constant rotation ratio with respect to the photoconductive drum 10. Such a charging roller 20 has a first passive roller gear, i.e., a charging roller gear 21, coaxially installed thereon. The charging roller gear 21 is gear-connected with the drum gear 11 to passively cooperate with the drum gear 11. Therefore, if the drum gear 11 is rotated, the charging roller gear 21 passively cooperates with and rotates at a predetermined gear ratio with the drum gear 11. Generally, the charging roller 20 has the predetermined gear ratio with respect to the photoconductive drum 10 in order to maintain a constant tangential velocity with respect to the photoconductive drum 10. Also, as the charging roller gear 21 passively operates by rotation of the drum gear 11, velocity variations due to slipping at the nip are compensated upon contact rotation.

Here, the charging roller gear 21 is made of materials such as a polyester material or an elastomer series material having a lower hardness than the drum gear 11. More specifically, the charging roller gear 21 preferably has a Shore hardness between 50D and 70D. As the charging roller gear 21 is made of a material having a relatively low hardness, impulses due to a pitch error between gear teeth of the drum gear 11 and the charging roller gear 21 thatmay be caused by the relation between the gear teeth are absorbed. Therefore, upon rotation of the charging roller 20, variations of an- inter-axis distance between the charging roller 20 and the photoconductive drum 10 due to pitch errors can be compensated, and impulses due to the variations of the inter-axis distance can be reduced as well.

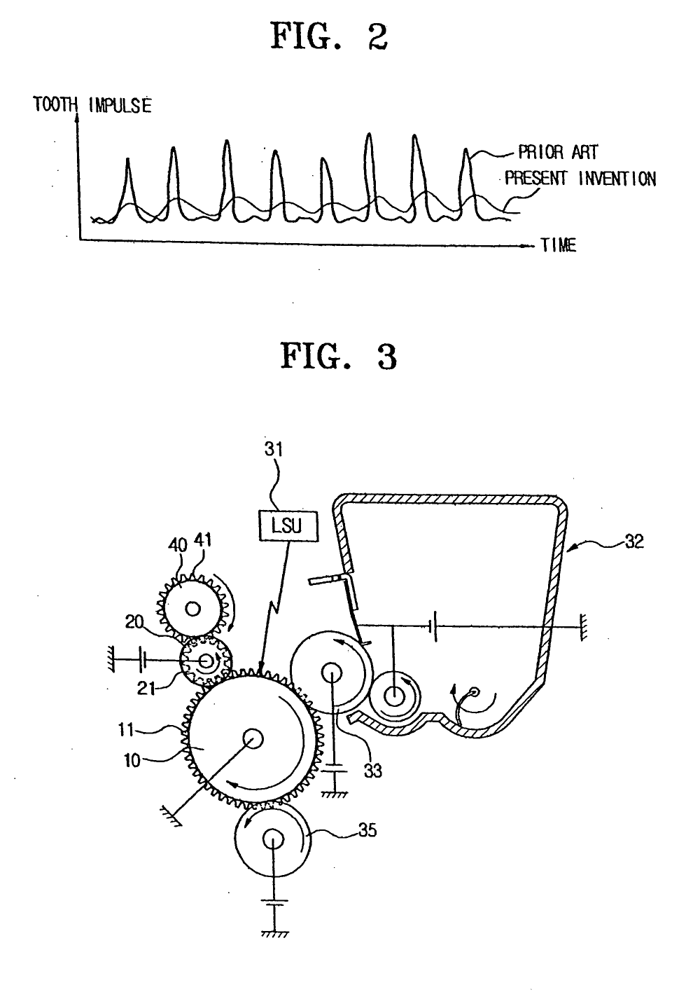

FIG. 2 is a graph comparing the impulses generated by the pitch error of the first passive roller gear 21 while in rotating engagement with the drum gear 11, where the first passive roller gear 21 is made of the material having the relatively lower hardness than the drum gear 11, as shown in the embodiment ofFIG. 1, with the impulses caused by the relation of gears used in the conventional art. As shown in FIG. 2, in the case of using a material having a strong hardness according to the conventional art, there occurs strong impulses in every pitch period of each gear tooth of the first passive roller gear. Due to such abrupt and repeated impulses, it becomes difficult for the first passive roller, i.e., the charging roller 20, to rotate at a constant rotation ratio with respect to the photoconductive drum 10. Namely, a deviation in rotational velocity is partially generated in the vicinity of the rotational period of the charging roller, and by such deviation, non-uniform charging may be generated. In contrast with the conventional art, in the case of the invention provided in the present embodiment, and illustrated in FIG. 1, the impulse or impulses that occur during every pitch period of the gear tooth of the first passive roller gear are remarkably reduced, and the intensity of the impulses becomes smooth. As is revealed by such results, it is expected that the impulses generated by the pitch error in the first passive roller gear 21, made of a material or materials having the lower hardness, is damped.

Referring to FIG. 3, according to another embodiment of the present invention, a second passive roller gear 41, coaxially installed on a second passive roller 40 and in contact with and rotated by the first passive roller 20, is additionally provided. The second passive roller gear 41 passively rotates by being gear-connected to the first passive roller gear 21. In the present embodiment, a cleaning roller 40 to clean the outer periphery of the charging roller 20, also the first passive roller 20, is taken for the second passive roller 40, as an example. However, it is to be noted that any other roller required to be driven similar to the cleaning roller may be used as the second passive roller 40. While in contact with and rotated by the charging roller 20 with a predetermined nip therebetween, the cleaning roller 40 removes unused toner or extraneous matter stuck on the outer periphery of the charging roller 20. Namely, if the extraneous matter or the unused toner partially contaminates the charging roller 20, it is difficult for the photoconductive drum 10 to be uniformly charged due to that contaminated part. For prevention of such contamination, the cleaning roller 40 cleans the charging roller 20 while smoothly rotating within a range sufficient not to damage the surface of the charging roller 20. To minimize slipping between the cleaning roller 40 and the charging roller 20, or to minimize variations in the rotational ratio therebetween, the second passive roller gear, i.e., the cleaning roller gear 41, is connected to the charging roller gear 21 and cooperates therewith. In the meantime, the cleaning roller gear 41 is also made of a material or materials having the low hardness, such as a polyester material or an elastomer series material in order to dampen impulses due to the pitch error between the gears 21 and 41. More specifically, the charging roller gear 21 preferably has a Shore hardness between 50D and 70D. As described above, the cleaning roller gear 41 is made of material or materials having the low hardness, so that impulses generated by variations of an inter-axis distance between the rollers 20 and 40 due to the gear pitch error can be compensated, and the generated impulses can be absorbed, thus roller damage can be prevented and a proper function of the roller can be performed.

In the meantime, in the embodiment FIG. 3, although a description has been provided, in which the charging roller gear 21 of the charging roller 20, rotated with respect to the photoconductive drum 10, and the cleaning roller gear 41 of the cleaning roller 40, rotated with respect to the charging roller 20, are made of a material or materials having a low hardness as described, such description is merely exemplary. Namely, the same effect can be provided with another passive gear coaxially installed on a predetermined roller in contact with the photoconductive drum 10 and rotated at a constant rotational ratio and made of the same material as the charging roller gear is made.

As is apparent from the foregoing, according to the apparatus to drive a roller used in the electrophotographic printer of the present invention, the gear of the charging roller rotated with respected to the photoconductive drum is made of a flexible material or materials having a low hardness so that impulses and velocity variations generated upon gear operation can be effectively absorbed. As a result, impulses and/or velocity variation influences applied to the charging roller are minimized, whereby the rotational ratio of the charging roller with respect to the photoconductive drum can be uniformly maintained.

Therefore, the surface of the photoconductive drum can be uniformly charged to a constant electric potential, and image quality is improved.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An apparatus to drive a roller used in an electrophotographic printer having a. photoconductive drum, comprising:
a drum gear having gear teeth and coaxially installed on the photoconductive drum to be rotated therewith; and
a first passive-roller in contact with and rotated by the photoconductive drum and having a first passive roller gear installed thereon and in contact with the drum gear to passively rotate,
wherein the first passive roller gear is made of a material having a lower hardness than the drum gear to absorb impulses due to a pitch error from gear teeth of the drum gear and the first passive roller gear.

2. The apparatus according to claim 1, wherein the first passive roller gear is made of a polyester material or an elastomer series material.

3. The apparatus according to claim 1, wherein the first passive roller is a charging roller to charge a surface of the photoconductive drum to a predetermined voltage.

4. The apparatus according to claim 2, wherein the first passive roller is a charging roller to charge a surface of the photoconductive drum to a predetermined voltage.

5. The apparatus according to claim 1, wherein the first passive roller gear has a Shore D hardness ranging from 50D to 70D.

6. The apparatus according to claim 2, wherein the first passive roller gear has a Shore D hardness ranging from 50D to 70D.

7. The apparatus according to claim 1, further comprising a second passive roller gear coaxially installed on a second passive roller and in contact with and rotated by the first passive roller to cooperate with the first passive roller gear.

8. The apparatus according to claim 2, further comprising a second passive roller gear coaxially installed on a second passive roller and in contact with and rotated by the first passive roller to cooperate with the first passive roller gear.

9. The apparatus according to claim 7, wherein the second passive roller is a cleaning roller to clean a surface of the first passive roller.

10. The apparatus according to claim 7, wherein the second passive roller gear is made of a polyester material or an elastomer series material.

11. An electrophotographic image forming apparatus forming an image on a recording medium including a photoconductive drum forming a nip with a first passive roller, comprising:
a drum gear installed on the photoconductive drum to be rotated therewith; and
a first passive roller gear installed on the first passive roller to be rotated therewith and in contact with the drum gear, the first passive roller gear being formed of a material that is softer than the material of the drum gear such that impulses from pitches between the drum gear and the first passive roller gear are absorbed to prevent velocity variations between the photoconductive drum and the first passive roller at the nip therebetween.

12. The apparatus according to claim 11, wherein the first passive roller gear is made of a polyester material or an elastomer series material.

13. The apparatus according to claim 11, wherein the first passive roller is a charging roller.

14. The apparatus according to claim 13, wherein the first passive roller gear is made of a polyester material or an elastomer series material.

15. The apparatus according to claim 12, wherein the first passive roller gear has a Shore D hardness ranging from 50D to 70D.

16. The apparatus according to claim 14, wherein the first passive roller gear has a Shore D hardness ranging from 50D to 70D.

17. The apparatus according to claim 11, further comprising:
a second passive roller forming a second nip with the first passive roller and to be rotated therewith; and
a second passive roller gear coaxially installed on the second passive roller and in contact with and rotated by the first passive roller gear.

18. The apparatus according to claim 17, wherein the second passive roller gear is made of a polyester material or an elastomer series material.

19. The apparatus according to claim 17, wherein the second passive roller is a cleaning roller.

20. The apparatus according to claim 19, wherein the second passive roller gear is made of a polyester material or an elastomer series material.

21. The apparatus according to claim 11, wherein the drum gear is coaxially installed on the photoconductive drum so that the drum gear and the photoconductive drum rotate on the same axis.

22. The apparatus according to claim 11, wherein the first passive roller gear is coaxially installed on the first passive roller so that the first passive roller gear and the first passive roller rotate on the same axis.

23. An image forming apparatus comprising:
a photoconductive drum;
a charging roller to charge a surface of the photoconductive drum;
a drum gear rotating the photoconductive drum; and
a passive gear in contact with the drum gear to rotate the charging roller, and having a lower hardness than the drum gear.

24. The apparatus according to claim 23, wherein the photoconductive drum and the charging roller form a nip therebetween, and the drum gear directly contacts the passive gear.

25. The apparatus according to claim 23, further comprising:
a second passive gear in contact with the passive gear to rotate together with the passive gear, and having a lower hardness than the drum gear.

26. The apparatus according to claim 24, wherein the passive gear comprises a first portion contacting the drum gear and a second portion contacting the second passive gear.

27. The apparatus according to claim 24, wherein the passive gear is disposed between the drum gear and the second passive gear.
